(19) United States
(12) Patent Application Publication
(10) Pub. No.: US 2010/0166369 A1
(43) Pub. Date: Jul. 1, 2010

(54) CROSS-TYPE LIGHT GUIDE

(75) Inventors: Kazutaka ISE, Miyagi-ken (JP); Naoki ITO, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/723,529

(22) Filed: Mar. 12, 2010

Related U.S. Application Data
(63) Continuation of application No. PCT/JP2008/067414, filed on Sep. 26, 2008.

(30) Foreign Application Priority Data
Sep. 27, 2007 (JP) 2007-251403

(51) Int. Cl. G02B 6/26; G02B 6/10

(52) U.S. Cl. 385/43

(57) ABSTRACT

With the width d of the incidence-side light guide portion of a first light guide and the width d of the incidence-side light guide portion of a second light guide, the width W1 of the emission-side light guide portion of the first light guide and the width W2 of the emission-side light guide portion of the second light guide are set to satisfy the relationship of d<W1=W2. In the first light guide, substantially all of the light that has been emitted from the incidence-side light guide portion and has been transmitted through the intersection can be captured by the emission-side light guide portion without being leaked out. In the second light guide, substantially all of the light that has been emitted from the incidence-side light guide portion and has been transmitted through the intersection can be captured by the emission-side light guide portion without being leaked out. Consequently, light loss can be reduced significantly.

### CLAIM OF PRIORITY

This application is a Continuation of International Application No. PCT/JP2008/067414 filed on Sep. 26, 2008, which claims benefit of the Japanese Patent Application No. 2007-251403 filed on Sep. 27, 2007, both of which are hereby incorporated by reference.

### BACKGROUND OF THE INVENTION

1. Field of the Invention

The present invention relates to light guides including two or more light guides intersecting one another at an intersection, and more particularly, to a cross-type light guide for reducing light loss at the intersection.

2. Description of the Related Art

Inventions for reducing light loss at an intersection of light guides are disclosed in, for example, Japanese Unexamined Patent Application Publication No. 50-92149, Japanese Unexamined Patent Application Publication No. 5-60929, and Japanese Unexamined Patent Application Publication No. 2003-131054.

Japanese Unexamined Patent Application Publication No. 50-92149 describes that light loss can be reduced by using a configuration in which the relationship between the refractive index n1 of a light guide portion and the refractive index n2 of an intersection portion is n2>n1.

In the inventions described in Japanese Unexamined Patent Application Publication No. 5-60929 and Japanese Unexamined Patent Application Publication No. 2003-131054, light loss is reduced by making the width of the intersection portion smaller than that of other portions in order to increase spot size.

However, in the invention described in Japanese Unexamined Patent Application Publication No. 50-92149, it is necessary to form a light guide portion and an intersection portion with different materials so that the refractive index of the light guide portion differs from the refractive index of the intersection portion. To do so, it is required, for example, to modify a resin in the intersection portion, to use a resin whose refraction index changes proportionally to an exposure time period, or to use a film or the like to change the relative refractive index of the cladding. However, in any case, there is a problem in that an extra process for changing the refraction index is required in the production.

In the cases of Japanese Unexamined Patent Application Publication No. 5-60929 and Japanese Unexamined Patent Application Publication No. 2003-131054, in order to obtain a small width at the intersection portion, the size of the light guide needs to be gradually reduced toward the intersection portion. Thus, there is a problem in that, in the case where the width is reduced at the incidence side, light that travels inside the light guide by total reflection always leaks out from the core thereof, whereby it is difficult to reduce light loss.

### SUMMARY OF THE INVENTION

The present invention solves the known problems described above and provides a cross-type light guide that can achieve low light loss, as compared with the related art, at the intersection of two or more light guides with a simple configuration.

The present invention provides a cross-type light guide in which two or more light guides intersect one another at an intersection, and in which the width of an emission-side light guide portion after the intersection is larger than the width of an incidence-side light guide portion, corresponding to the emission-side light guide portion, before the intersection.

In the present invention, light loss can be reduced by increasing the width of the emission-side light guide portion at the intersection.

In addition, unlike the light guides of the related art, since the size of the light guide of the present invention does not need to be gradually reduced toward the intersection, light that travels inside the light guide by total reflection does not leak out from the core, and thus, light loss can be effectively reduced.

In this case, the center line in the width direction of the emission-side light guide portion is preferably shifted in the width direction with respect to the center line in the width direction of the incidence-side light guide portion.

In the above case, by shifting the center line at the emission side with respect to the center line at the incidence side, it is possible to prevent the width of the emission-side light guide portion from being increased to an unnecessarily large width. That is, the width of the emission-side light guide portion can be set to an optimal width.

Furthermore, the width of each of the emission-side light guide portions is preferably larger than the width of the corresponding incidence-side light guide portion.

This can reduce light loss in all of the light guides intersecting one another at the intersection.

In addition, the cross-type light guide may be constituted by a first light guide and a second light guide intersecting each other at the intersection, and in which an intersection angle φ between the first light guide and the second light guide is 90°.

Generally, light guides are formed by transfer. Therefore, if an intersection angle is acute, it is difficult to transfer the exact shape. With a configuration in which two light guides intersect at an intersection angle of 90° as described above, a desired shape can be transferred accurately, whereby a light guide having a stable performance can be obtained.

In the light guide of the present invention, the width of the emission-side light guide portion is larger than that of the incidence-side light guide portion, and this enables the emission-side light guide portion to receive substantially all the light. Therefore, light leakage at the intersection can be prevented and hence light loss can be reduced significantly.

In addition, the width of the emission-side light guide portion at the intersection can be set to an optimal width for light loss reduction. This prevents the width of the emission-side light guide portion from being increased to an unnecessarily large width, whereby a compact and lightweight light guide can be realized.

### BRIEF DESCRIPTION OF THE DRAWINGS

FIG. 1 is a plan view of a cross-type light guide illustrating a first embodiment of the present invention;

FIG. 2 is a plan view of a cross-type light guide illustrating a second embodiment of the present invention; and

FIG. 3 is a plan view of a cross-type light guide illustrating a third embodiment of the present invention.

### DESCRIPTION OF THE PREFERRED EMBODIMENTS

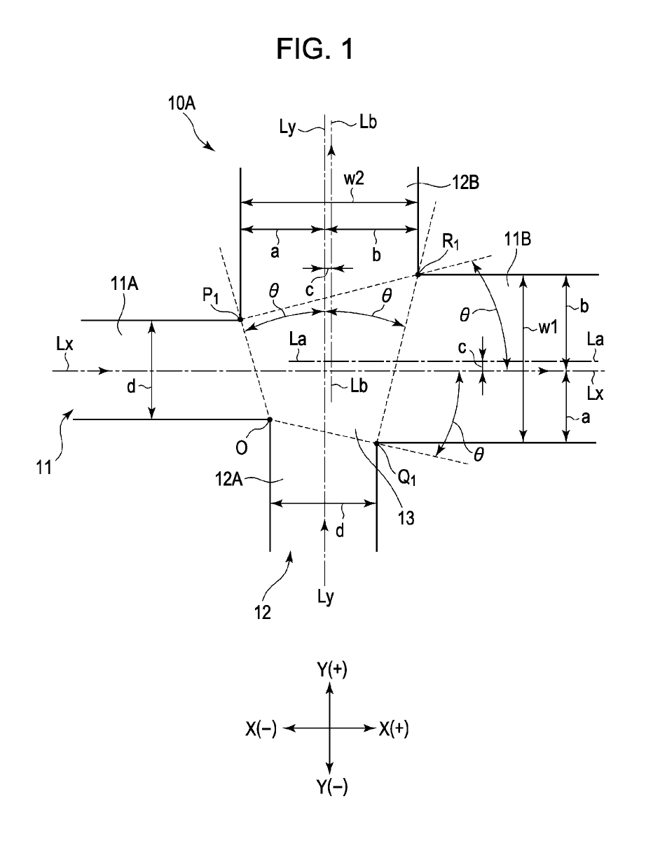

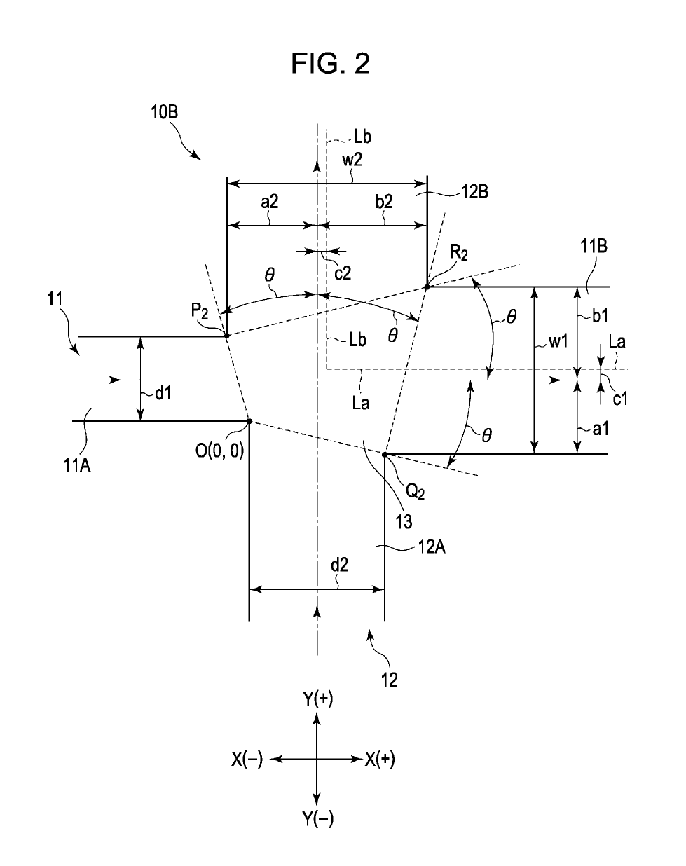

FIG. 1 is a plan view of a cross-type light guide illustrating a first embodiment of the present invention, and FIG. 2 is a plan view of a cross-type light guide illustrating a second embodiment of the present invention.

A light guide of the present invention is used in, for example, electronic equipment such as a mobile phone to guide light emitted from a light source to a specific key thereof in order to illuminate the area around the key for better visibility.

Note that throughout the following descriptions, a first light guide 11, a second light guide 12, and an intersection 13 that constitute a cross-type light guide 10A of the present invention are all composed of the same material, and that, as with light guides of the related art, the cross-type light guide 10A has a core at the center and a cladding therearound.

Referring to FIG. 1, the cross-type light guide 10A has an incidence-side light guide portion 11A at the X(−) side and an emission-side light guide portion 11B at the X(+) side with the intersection 13 therebetween. Similarly, the cross-type light guide 10A has an incidence-side light guide portion 12A at the Y(−) side and an emission-side light guide portion 12B at the Y(+) side with the intersection 13 therebetween.

The incidence-side light guide portion 11A and the emission-side light guide portion 11B constitute the first light guide 11, and the incidence-side light guide portion 12A and the emission-side light guide portion 12B constitute the second light guide 12.

In the cross-type light guide 10A illustrated in the first embodiment, the first light guide 11 and the second light guide 12 intersect each other at right angles. In the first light guide 11, light is transmitted from the incidence-side light guide portion 11A to the emission-side light guide portion 11B through the intersection 13. In the second light guide 12, light is transmitted from the incidence-side light guide portion 12A to the emission-side light guide portion 12B through the intersection 13. Note that the intersection 13 corresponds to a portion enclosed by an origin O, an intersection point P1, an intersection point Q1, and an intersection point R1, which will be described later.

Since there is no wall at the intersection 13, light entering the intersection 13 from the incidence-side light guide portions 11A and 12A is respectively scattered at a total reflection angle θ, at maximum, of the first and second light guides 11 and 12. Therefore, as described later, when the widths of the emission-side light guide portion 11B and the emission-side light guide portion 12B are increased in order to capture as much light as possible, light loss due to light leakage at the intersection 13 can be reduced.

As illustrated in FIG. 1, the cross-type light guide 10A of the first embodiment is configured so that, where the width of the incidence-side light guide portion 11A of the first light guide 11 and the width of the incidence-side light guide portion 12A of the second light guide 12 are d, the width of the emission-side light guide portion 11B of the first light guide 11 is W1, and the width of the emission-side light guide portion 12B of the second light guide 12 is W2, the widths d, W1, and W2 have the relationship of d<W1=W2.

With the widths having the relationship of d<W1=W2, in the first light guide 11, substantially all of the light that has been emitted from the incidence-side light guide portion 11A and has been transmitted through the intersection 13 can be captured by the emission-side light guide portion 11B without being leaked out. At the same time, in the second light guide 12, substantially all of the light that has been emitted from the incidence-side light guide portion 12A and has been transmitted through the intersection 13 can be captured by the emission-side light guide portion 12B without being leaked out. Consequently, light loss in the cross-type light guide 10A can be reduced significantly.

It is supposed that an intersection point between the incidence-side light guide portion 11A of the first light guide 11 and the incidence-side light guide portion 12A of the second light guide 12 is the origin O (coordinates (0, 0)), an intersection point between the incidence-side light guide portion 11A of the first light guide 11 and the emission-side light guide portion 12B of the second light guide 12 is the intersection point P1, an intersection point between the incidence-side light guide portion 12A of the second light guide 12 and the emission-side light guide portion 11B of the first light guide 11 is the intersection point Q1, and an intersection point between the emission-side light guide portion 11B of the first light guide 11 and the emission-side light guide portion 12B of the second light guide 12 is the intersection point R1. In order to form a shape for capturing all of the light emitted at the angle θ from the incidence-side light guide portion 11A and the incidence-side light guide portion 12A respectively by the emission-side light guide portion 11B and the emission-side light guide portion 12B, the coordinates for each of the intersection points P1, R1, and Q1 are determined as follows.

$$Intersection point {P}_{1} = ( - d \cdot tan θ , d )$$

$$Intersection point {R}_{1} = ( \frac{d \cdot ( 1 + {tan}^{2} θ )}{1 - tan θ} , \frac{d \cdot ( 1 + {tan}^{2} θ )}{1 - tan θ} )$$

$$Intersection point {Q}_{1} = ( d , - d \cdot tan θ )$$

The total reflection angle θ can be an angle for total reflection at which light is totally reflected in the light guides 11 and 12. Note that in the case where the wavelength of the light entering the first light guide 11 is different from the wavelength of the light entering the second light guide 12, the total reflection angle θ of the shorter wavelength is selected. Furthermore, in the case where the light includes multiple wavelengths, the total reflection angle θ of the wavelength having the maximum total reflection angle is selected.

Thus, the width W1 of the emission-side light guide portion 11B of the first light guide 11 and the width W2 of the emission-side light guide portion 12B of the second light guide 12 can be represented as follows.

$$W 1 = W 2 = \frac{d \cdot ( 1 + {tan}^{2} θ )}{1 - tan θ} + d \cdot tan θ \qquad [ Equation 1 ]$$

As the widths W1 and W2 respectively of the emission-side light guide portion 11B and the emission-side light guide portion 12B are reduced less than the width given by Equation 1, the amount of light leakage increases. In addition, as the widths W1 and W2 exceed the width given by Equation 1, the widths W1 and W2 respectively of the emission-side light guide portion 11B and the emission-side light guide portion 12B increase, resulting in an increase of the size of the cross-type light guide 10A. Thus, it is preferable that the width d and the widths W1 and W2 have the relationship of Equation 1.

Accordingly, in terms of preventing light leakage, it is effective in the first embodiment that both the widths W1 and W2 respectively of the emission-side light guide portion 11B of the first light guide 11 and the emission-side light guide portion 12B of the second light guide 12 are set to the width given by Equation 1 or larger.

However, simply increasing the widths W1 and W2 respectively of the emission-side light guide portion 11B and the emission-side light guide portion 12B is not sufficient.

That is, as illustrated in FIG. 1, in the case of the cross-type light guide 10A in which light enters from two directions, when a center line Lx-Lx in the width direction of the incidence-side light guide portion 11A is taken as a reference line, a distance a from the center line Lx-Lx to the intersection point Q1 and a distance b from the center line Lx-Lx to the intersection point R1 has the relationship of a<b. Similarly, when a center line Ly-Ly in the width direction of the incidence-side light guide portion 12A is taken as a reference line, a distance a from the center line Ly-Ly to the intersection point P1 and a distance b from the center line Ly-Ly to the intersection point R1 has the relationship of a<b.

Therefore, as described below, it is preferable that a center line in the width direction of the emission-side light guide portion 11B and a center line in the width direction of the emission-side light guide portion 12B be shifted.

That is, as illustrated in FIG. 1, in the first light guide 11, the emission-side light guide portion 11B is set so that a center line La-La in the width direction of the emission-side light guide portion 11B is shifted by a predetermined amount c of shift in the width direction Y(+) with respect to the center line Lx-Lx in the width direction of the incidence-side light guide portion 11A. Similarly, in the second light guide 12, the emission-side light guide portion 12B is set so that a center line Lb-Lb in the width direction of the emission-side light guide portion 12B is shifted by a predetermined amount c of shift in the width direction X(+) with respect to the center line Ly-Ly in the width direction of the incidence-side light guide portion 12A of the second light guide 12.

With these settings, in addition to simply increasing the widths, the widths W1 and W2 respectively of the emission-side light guide portion 11B and the emission-side light guide portion 12B can be set to optimal width given by Equation 1 above. Therefore, there is no need to increase the widths W1 and W2 respectively of the emission-side light guide portion 11B and the emission-side light guide portion 12B to an unnecessarily large width. As a result, the cross-type light guide 10A can be made smaller and lighter without an unnecessary increase in size.

Note that, although in the present invention the width is increased in both the emission-side light guide portions of the two light guides intersecting each other, the present invention is not limited to this configuration. The width W1 or W2 may be increased in either one of the emission-side light guide portion 11B of the first light guide 11 and the emission-side light guide portion 12B of the second light guide 12. In such a case, light loss can be reduced only in the light guide in which the width W1 or W2 has been increased.

Next, a second embodiment of the present invention will be discussed.

A cross-type light guide 10B according to the second embodiment of the present invention illustrated in FIG. 2 corresponds to a modification of the cross-type light guide 10A illustrated in the first embodiment. Therefore, in the following, features different from the first embodiment will be mainly described.

The second embodiment illustrated in FIG. 2 has a different feature from the first embodiment in that a width d1 of the incidence-side light guide portion 11A of the first light guide 11 differs from a width d2 of the incidence-side light guide portion 12A of the second light guide 12 (d1≠d2).

Therefore, in the second embodiment, the coordinates for each of intersection points P2, R2, and Q2 are determined as follows.

$$Intersection point {P}_{2} = ( - d 1 \cdot tan θ , d 1 )$$

$$Intersection point {R}_{2} = ( \begin{matrix}\frac{( 1 + {tan}^{2} θ ) \cdot ( d 1 \cdot tan θ + d 2 )}{1 - {tan}^{2} θ} , \\ \frac{( 1 + {tan}^{2} θ ) \cdot ( d 2 \cdot tan θ + d 1 )}{1 - {tan}^{2} θ}\end{matrix} )$$

$$Intersection point {Q}_{2} = ( d 2 , - d 2 \cdot tan θ )$$

Accordingly, the width W1 of the emission-side light guide portion 11B of the first light guide 11 is as follows.

$$W 1 = \frac{( 1 + {tan}^{2} θ ) \cdot ( d 2 \cdot tan θ + d 1 )}{1 - {tan}^{2} θ} + d 2 \cdot tan θ \qquad [ Equation 2 ]$$

In addition, the width W2 of the emission-side light guide portion 12B of the second light guide 12 is as follows.

$$W 2 = \frac{( 1 + {tan}^{2} θ ) \cdot ( d 1 \cdot tan θ + d 2 )}{1 - {tan}^{2} θ} + d 1 \cdot tan θ \qquad [ Equation 3 ]$$

Thus, as with the first embodiment, when the width W1 of the emission-side light guide portion 11B of the first light guide 11 is set to the width given by Equation 2 or larger and when the width W2 of the emission-side light guide portion 12B of the second light guide 12 is set to the width given by Equation 3 or larger, light leakage can be prevented.

In the second embodiment, as illustrated in FIG. 2, for the first light guide 11, the emission-side light guide portion 11B is preferably set so that the center line La-La in the width direction of the emission-side light guide portion 11B is shifted by a predetermined amount c1 of shift in the width direction Y(+) with respect to the center line Lx-Lx in the width direction of the incidence-side light guide portion 11A. For the second light guide 12, the emission-side light guide portion 12B is preferably set so that the center line Lb-Lb in the width direction of the emission-side light guide portion 12B is shifted by a predetermined amount c2 of shift in the width direction X(+) with respect to the center line Ly-Ly in the width direction of the incidence-side light guide portion 12A of the second light guide 12.

With these settings, the widths W1 and W2 of the emission-side light guide portion 11B and the emission-side light guide portion 12B can be set to optimal widths respectively given by Equations 2 and 3 above. Therefore, there is no need to increase the widths W1 and W2 respectively of the emission-side light guide portion 11B and the emission-side light guide portion 12B to an unnecessarily large width. As a result, the cross-type light guide 10B can be made smaller and lighter.

Next, a third embodiment of the present invention will be discussed.

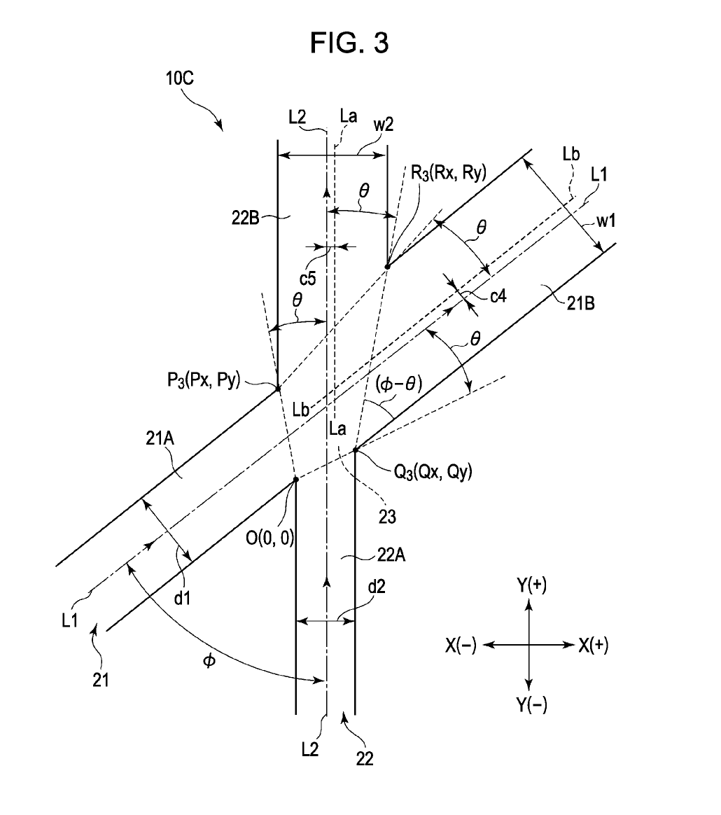

FIG. 3 is a plan view of a cross-type light guide illustrating the third embodiment of the present invention. A cross-type light guide 10C illustrated in the third embodiment differs from the cross-type light guides 10A and 10B illustrated in the first and second embodiments in that the first light guide 11 and the second light guide 12 intersect each other at an angle other than a right angle.

In the third embodiment, an incidence-side light guide portion 21A and an emission-side light guide portion 21B of a first light guide 21 are respectively located at the X(−) side and the X(+) side with an intersection 23 therebetween. In addition, an incidence-side light guide portion 22A and an emission-side light guide portion 22B of a second light guide 22 are respectively located at the Y(−) side and the Y(+) side with the intersection 23 therebetween. Note that the intersection 23 corresponds to a portion enclosed by the origin O, an intersection point P3, an intersection point Q3, and an intersection point R3, which will be described later.

In the figure, the width of the incidence-side light guide portion 21A of the first light guide 21 is denoted as dl and the width of the incidence-side light guide portion 22A of the second light guide 22 is denoted as d2. Furthermore, a center line L1-L1 of the first light guide 21 and a center line L2-L2 of the second light guide 22 intersect at the intersection angle φ.

It is supposed that an intersection point between the incidence-side light guide portion 21A of the first light guide 21 and the incidence-side light guide portion 22A of the second light guide 22 is the origin O (coordinates (0, 0)), an intersection point between the incidence-side light guide portion 21A of the first light guide 21 and the emission-side light guide portion 22B of the second light guide 22 is the intersection point P3 (coordinates (Px, Py)), an intersection point between the incidence-side light guide portion 22A of the second light guide 22 and the emission-side light guide portion 21B of the first light guide 21 is the intersection point Q3 (coordinates (Qx, Qy)), and an intersection point between the emission-side light guide portion 21B of the first light guide 21 and the emission-side light guide portion 22B of the second light guide 22 is the intersection point R3 (coordinates (Rx, Ry)).

The coordinates for each of the intersection points P3, Q3, and R3 are determined as follows.

$${P}_{x} = - d 1 \cdot sin θ / sin ( φ + θ )$$

$${P}_{y} = - d 1 \cdot cos θ / sin ( φ + θ )$$

$${Q}_{x} = d 2$$

$${Q}_{y} = d 2 / tan ( φ + θ )$$

$${R}_{x} = \frac{( {P}_{y} - {Q}_{y} ) \cdot tan ( φ - θ ) \cdot tan θ - ( {P}_{x } \cdot tan θ - {Q}_{x} \cdot tan ( φ - θ ) )}{tan ( φ - θ ) - tan θ}$$

$${R}_{y} = \frac{( {P}_{y} \cdot tan ( φ - θ ) - {Q}_{y} \cdot tan θ ) - ( {P}_{x } \cdot {Q}_{y} )}{tan ( φ - θ ) - tan θ}$$

Thus, the width W1 of the emission-side light guide portion 21B of the first light guide 21 is as follows.

$$\begin{matrix}W 1 = \vert {R}_{3} {Q}_{3} \vert \cdot sin ( φ - θ ) \\ = \sqrt{{( {R}_{x} - {Q}_{x} )}^{2} + {( {R}_{y} - {Q}_{y} )}^{2}} \cdot sin ( φ - θ )\end{matrix} \qquad [ Equation 4 ]$$

In addition, the width W2 of the emission-side light guide portion 22B of the second light guide 22 is as follows.

$$\begin{matrix}W 2 = {R}_{x} - {P}_{x} \\ = \frac{\begin{matrix}( {P}_{y} - {Q}_{y} ) \cdot tan ( φ - θ ) \cdot tan θ - \\ ( {P}_{x } \cdot tan θ - {Q}_{x} \cdot tan ( φ - θ ) )\end{matrix}}{tan ( φ - θ ) - tan θ} + \\ d 1 \cdot sin θ / sin ( φ + θ )\end{matrix} \qquad [ Equation 5 ]$$

Accordingly, when the first light guide 21 and the second light guide 22 intersect each other with the intersection points P3, Q3 and R3 being set to the above-described coordinates, an adequate width can be secured for the widths W1 and W2, and this enables the emission-side light guide portions 21B and 22B to respectively receive the light entering from the incidence-side light guide portions 21A and 22A without leakage.

Note that each of the intersection points P3, Q3, and R3 does not necessarily need to completely match the above-described coordinates. However, when the intersection points are set as close to the above-described coordinates as possible, light loss can be reduced. Furthermore, the widths of the emission-side light guide portions can be prevented from being increased to an unnecessarily large width, whereby the cross-type light guide 10C can be made smaller and lighter.

In this case, as illustrated in FIG. 3, light loss may be reduced much further by shifting the center line La-La in the width direction of the emission-side light guide portion 21B from the center line L1-L1 in the width direction of the incidence-side light guide portion 21A by an appropriate amount c4 of shift, and by shifting the center line Lb-Lb in the width direction of the emission-side light guide portion 22B from the center line L2-L2 in the width direction of the incidence-side light guide portion 22A by an appropriate amount c5 of shift.

### EXAMPLES

In the following examples, the widths d1 and d2 respectively of the incidence-side light guide portions 21A and 22A are 0.05 mm, the intersection angle φ is 90°, and the total reflection angle θ is 10°.

In this case, the coordinates of each of the intersection points P3, Q3, and R3 are as follows.

P3(Px, Py)=P3(−0.09, 0.0053)

Q3(Qx, Qy)=Q3(0.050, 0.022)

R3(Rx, Ry)=R3(0.069, 0.129)

Table 1 summarizes the simulation results of the present invention and comparative examples.

Table 1 shows the results of Comparative Example 1, Comparative Example 2, and Example 1. Comparative Example 1 is carried out by using a configuration in which the widths W1 and W2 respectively of the emission-side light guide portions 21B and 22B are identical to the widths d1 and d2 respectively of the incidence-side light guide portions 21A and 22A. Comparative Example 2 is carried out by using a configuration in which the widths W1 and W2 respectively of the emission-side light guide portions 21B and 22B are larger than the widths d1 and d2 respectively of the incidence-side light guide portions 21A and 22A. Example 1 is carried out by using a configuration in which the widths W1 and W2 respectively of the emission-side light guide portions 21B and 22B are larger than the widths d1 and d2 respectively of the incidence-side light guide portions 21A and 22A, and in which the center lines L1 and L2 respectively of the emission-side light guide portions 21B and 22B are shifted by predetermined amounts in the respective width directions.

TABLE 1

| | Width d1, d2 of | Width W1, W2 of | |
|---|---|---|---|
| | incidence-side light | emission-side light | Light loss |
| | guide portions [mm] | guide portions [mm] | [dB] |
| Comparative | 0.05 | 0.05 | 0.35 |
| Example 1 | | | |
| (no shift) | | | |
| Comparative | 0.05 | 0.07 | 0.01 |
| Example 2 | | | |
| (no shift) | | | |
| Example 1 | 0.05 | 0.07 | 0 |
| (with shift) | | | |

As shown in Comparative Example 1 and Comparative Example 2, the effect of reducing light loss can be obtained just by increasing the widths W1 and W2 respectively of the emission-side light guide portions 21B and 22B to be larger than the widths d1 and d2 respectively of the incidence-side light guide portions 21A and 22A, but the light loss cannot be reduced to zero.

In contrast, as shown in Example 1 embodying the present invention, it is understood that by shifting the center lines in the width directions of the emission-side light guide portions 21B and 22B, the loss in terms of light can be reduced to zero.

As described above, unlike the light guides of the related art, the size of the light guide of the present invention does not need to be gradually reduced toward the intersection. Therefore, light that travels inside the light guides by total reflection does not leak out from the core, and thus, light loss can be effectively reduced.

Although the above-described embodiments illustrate the case where two light guides intersect each other at a single intersection, the present invention is not limited to this case. The present invention may be configured so that two or more light guides intersect one another at a single intersection. In such a case, although more complex calculation may be required, the coordinates of the intersection points and the widths of the emission-side light guide portions can be set by using a method similar to the above-described method.

Furthermore, although in the above-described embodiments, the amounts of shift of the center lines in the width directions are not determined for the emission-side light guide portions, optimal amounts of shift can be calculated from the coordinates of the intersection points O, P, Q, and R described above.

What is claimed is:

1. A cross-type light guide having a first light guide and a second light guide intersecting each other at an intersection:
wherein a width of an emission-side light guide portion of the first light guide, after the intersection, is larger than a width of an incidence-side light guide portion thereof, before the intersection, corresponding to the emission-side light guide portion, and
wherein a width of an emission-side light guide portion of the second light guide, after the intersection, is larger than a width of an incidence-side light guide portion thereof, before the intersection, corresponding to the emission-side light guide portion.

2. The cross-type light guide according to claim 1,
wherein a center line in a width direction of the emission-side light guide portion of the first light guide is shifted with respect to a center line in a width direction of the incidence-side light guide portion corresponding to the emission-side light guide portion of the first light guide.

3. The cross-type light guide according to claim 2,
wherein the center line in the width direction of the emission-side light guide portion of the first light guide is shifted in a direction in which the emission-side light guide portion of the second light guide exists with respect to the center line in the width direction of the incidence-side light guide portion corresponding to the emission-side light guide portion of the first light guide.

4. The cross-type light guide according to claim 2,
wherein a center line in a width direction of the emission-side light guide portion of the second light guide is shifted with respect to a center line in a width direction of the incidence-side light guide portion corresponding to the emission-side light guide portion of the second light guide.

5. The cross-type light guide according to claim 4,
wherein the center line in the width direction of the emission-side light guide portion of the second light guide is shifted in a direction in which the emission-side light guide portion of the first light guide exists with respect to the center line in the width direction of the incidence-side light guide portion corresponding to the emission-side light guide portion of the second light guide.

6. The cross-type light guide according to claim 3,
wherein a center line in a width direction of the emission-side light guide portion of the second light guide is shifted with respect to a center line in a width direction of the incidence-side light guide portion corresponding to the emission-side light guide portion of the second light guide.

7. The cross-type light guide according to claim 6,
wherein the center line in the width direction of the emission-side light guide portion of the second light guide is shifted in a direction in which the emission-side light guide portion of the first light guide exists with respect to the center line in the width direction of the incidence-side light guide portion corresponding to the emission-side light guide portion of the second light guide.

8. The cross-type light guide according to claim 1,
wherein an intersection angle φ between the first light guide and the second light guide is 90°.
